(19) United States
(12) Patent Application Publication
(10) Pub. No.: US 2014/0269697 A1
(43) Pub. Date: Sep. 18, 2014

(54) INTERNET PROTOCOL CALL SIGNAL INTERRUPTER FOR SELECTIVE BLOCKING OF INTERNET VOICE CALLS

(71) Applicants: Algis Salys, Oakwood Hills, IL (US); John Vitale, Monroe Township, NJ (US); Farhang Frank Mehr, Merrimack, NH (US)

(72) Inventors: Algis Salys, Oakwood Hills, IL (US); John Vitale, Monroe Township, NJ (US); Farhang Frank Mehr, Merrimack, NH (US)

(73) Assignee: SIGNAL PERFECTION LTD., INC., Tampa, FL (US)

(21) Appl. No.: 14/105,740

(22) Filed: Dec. 13, 2013

Related U.S. Application Data
(60) Provisional application No. 61/791,691, filed on Mar. 15, 2013.

(51) Int. Cl. H04L 12/927

(52) U.S. Cl. CPC H04L 47/80
USPC 370/389

(57) ABSTRACT

An accessory or device for use with a computer. Computers can hold video and audio conferences over the internet. by the well-known Voice Over Internet Protocol, VOIP, standards defined by the ITU and IETF. An internet protocol interrupter accessory or device is disclosed and comprises: a) a filter which: i) receives data packets from the network; ii) passes data packets affiliated with the video conference to the computer; and iii) blocks data packets affiliated with a data port from reaching the computer; and b) a switch which selectively activates and de-activates the blocking. An internet protocol call signal interruption method is also disclosed comprising the steps of: a) receiving data packets from a network; b) examining the packets; and c) if examination shows that packets are affiliated with a specific port, then blocking such packets from reaching a computer.

### CROSS-REFERENCE TO RELATED APPLICATION

The present application claims priority to provisional U.S. Application Ser. No. 61/791,691 filed Mar. 15, 2013, to which Applicant claims the benefit of the earlier filing date. That provisional application is incorporated herein by reference and made a part hereof.

### BACKGROUND OF THE INVENTION

1. Field of the Invention

The invention blocks calls to and from a computer connected to a network, such as the internet.

2. Description of the Related Art

FIG. 1 illustrates 2 computers 3 located at two different sites, which are participating in a video conference over the internet 4. The screen 6 of each computer 3 displays pictures of the conference participants, and each computer 3 contains a microphone 9 and loudspeaker 11 (not labeled on all computers 3) so that the participants can maintain a conversation as part of the video conference.

When these computers participate in a video over IP call they use specific network port ranges to allow communication between each device to exchange call signaling and media information in order to perform a video call. The same happens when the computers perform a voice over IP call.

The phone calls just described are assumed to be innocent calls which are merely disruptive. However, it is possible that a hacker may place malicious calls or an innocent unsolicited call to one of the computers from another computer on the Internet.

What is needed, therefore, is a device, system and process for blocking specific data packets between the network.

### SUMMARY OF THE INVENTION

The invention provides an approach to suppressing or blocking calls from disruptions to computer usage on networks generally.

An object of the invention is to provide a computer device or accessory which blocks specific data traffic.

A further object is to provide a computer device or accessory which blocks incoming and outgoing calls, such as telephone calls, over an internet connection.

A further object is to enhance computer security using apparatus which cannot be altered or controlled remotely through the internet, nor by the computer to which it delivers data.

In one form of the invention, a computer device or accessory is connected in series between a computer and the computer's local area network or wide area network (i.e., internet) connection. The device or accessory can be activated and de-activated by a switch connected to it. A visual signal, such as an LED, indicates whether the device or accessory is activated or not.

When activated, the device or accessory blocks specific incoming and outgoing data packets to and from the computer, as by (examining the port. If the examination indicates that a port is associated with a VOIP call, then the device or accessory blocks the packet being sent over specific ports. Such packets are blocked whether they are outgoing from the computer or incoming to the computer. All other data packets are passed without interference.

When the device or accessory is de-activated, it performs no function, except possibly to display a signal indicating its de-activated state, and it passes all internet data packets without interference.

Significantly, the operations performed by the device or accessory are performed by one or more programs or computer instructions running on a microprocessor. Those programs or computer instructions are stored in memory of the device or accessory, and this memory is not accessible through the internet cable to the device or accessory. Further, it is not possible for a hacker to load code into the microprocessor through the internet cable to the device or accessory. Therefore, the operation of the device or accessory cannot be altered, activated, or de-activated by a user or even a hacker using the internet. The only access to the microprocessor, memory, and internal circuitry is through a physical connector on the device or accessory itself, such as a serial connector.

Further, the alteration, activation, and de-activation cannot be accomplished by the computer to which the device or accessory is delivering data.

In one aspect, one embodiment of the invention comprises a protocol interrupter device, comprising a first connector or interface adapted to be connected to a data packet-switched network, a second connector or interface adapted to be connected to a computer, circuitry which examines data packets received from the network, blocks predetermined packets from reaching the second connector or interface which are found to originate from a predetermined port and passes all other packets to the second connector or interface.

These and other objects and advantages of the invention will be apparent from the following description, the accompanying drawings and the appended claims.

### BRIEF DESCRIPTION OF THE ACCOMPANYING DRAWINGS

FIG. 1 illustrates a video conference as held in the prior art;

FIG. 2 illustrates the architecture of one form of the invention;

FIG. 3 illustrates one view of the invention; and

FIG. 4 is a flow chart illustrating logic or algorithm undertaken by one form of the invention.

### DETAILED DESCRIPTION OF PREFERRED EMBODIMENTS

FIG. 2 illustrates one embodiment of the invention comprising an Internet Protocol Call Signal interrupter device, system or apparatus 10, hereinafter referred to as ICSI device 10 for ease of description. The ICSI device 10 comprises a box or housing 10a that houses circuitry 14 and a plurality of interfaces described later. Block 14 within ICSI device 10 represents the electronic circuitry 14, which includes a microprocessor 14a, memory 14b, and associated computer program logic or instructions that perform the functions (including the algorithm described later herein relative to FIG. 4) described herein.

The housing 10a further comprises a button connector, interface or jack 36 for enabling the ICSI device 10 to be coupled to an activation/deactivation switch 16. In the embodiment being described, the button connector, interface or jack 36 comprises a RJ45/RJ11 interface, connector or jack. The switch 16 has an ON-OFF button 16a adapted to activate and de-activate the operation of the circuitry 14. A green light-emitting diode or LED 18 (LED—Light Emitting Diode) is illuminated when the switch 16 is OFF, at which time the ICSI device 10 is not active. A red LED 20 is illuminated when the switch 16 is ON, when the ICSI device 10 is active. The operation of switch 16 and circuitry 14 are described later herein in more detail.

A connector, jack or interface 26 is located on the housing 10a and is connectable to a local computer 3 using a conventional cable, such as an Ethernet cable 12. In the example, the connector, jack or interface 26 is an in-line RJ45 Ethernet interface or jack. The internet cable 12, such as an Ethernet™ cable, connects the computer 3 to a network, such as a data packet switched network or the Internet (not shown). When a user activates the circuitry 14 by actuating the button 16a on switch 16 so that the green light is lit, the ICSI device 10 is not active, and all data packets travel freely between connector, jack or interface 26 and a second connector, jack or interface 28 located on the housing 10a and through an internet cable 15 to allow the data packets to be sent and received by computer 3 over the network. In this embodiment, the connector, jack or interface 28 is also an in-line RJ45 Ethernet interface or jack. It is important to note that data packets travel freely between connector 28 to connector 26 during the non-active or “green-light” mode, thereby allowing the computer 3 to freely receive data packets from the network and to transmit data packets over the network. The data packets may be, for example, transmission control protocol (TCP) or user datagram protocol (UDP) packets.

When a user activates the ON-OFF button 16a of switch 16 to an active state or mode, the red light is illuminated and the circuitry 14 examines the data packets running between connectors 26 and 28 in both directions. In one embodiment, when the switch 16 is in an active state or mode, all data traffic on the associated with at least one or a plurality of ports is blocked. As mentioned, in one embodiment all data traffic via the preselected or predetermined ports is blocked.

Optional indicia, such as a printed label 22, can be provided on the housing 16b of the switch 16 that explains the meaning of each LED. For example, the label 24 associated with the red LED 20 may read “IN CALL BLOCKING MODE.” The label 24 associated with the green LED 18 may read “NOT IN CALL BLOCKING MODE.” The labels 22, 24 may be useful in countries outside the United States, where the colors red and green may not be self-explanatory. Also, other colors or means may be used to identify or notify the user of the different modes. For example, a blinking light or sound may be used to indicate an active mode of the ICSI device 10.

Returning to the data packet filtering by the ICSI device 10, one approach to making inquiry is for the processor 14a to examine whether a data packet originates from, or is destined to, a port which is known to handle voice calls. The term “port” is a term-of-art in the science of networking. One type of port is a 16-bit unsigned integer, ranging from 1 to 65,535 (zero is possibly not used), which is associated with an IP (Internet Protocol) address. In general, both a port designation and an IP address are contained within the data packet under consideration. The IP address identifies a location within the internet, such as a server at a government, corporate or individual's installation or location, and the port identifies, at that location, a process or computer program for which a data packet is intended or from which a data packet originates.

From one perspective, the pair comprising (1) the IP address and (2) the port cooperate together to act as an internet address, although a more specific address than an IP address alone. By analogy, a common post office address is similar to an IP address. For example, an illustrative post office address is 1234 Durwood Street, Tampa, Fla. 12345. If one adds the name “John Doe” to that address, that name is similar to a port. The name gives a more specific address or identification than the street address alone, as a port address gives a more specific address when added to an IP address. This is important because there are many different available ports, just as multiple people may reside at the address in the analogy mentioned.

A specific example of a port to be blocked is port 1720 under TCP, Transmission Control Protocol, following the ITU-T H.323 standard. Another example is port 5060 under IETF SIP, Session Initiation Protocol. When the switch 16 is activated, all data packets associated with either port are blocked, so that they can neither enter into, nor exit from, the computer 3. Under current technology and standards, these two ports are associated with voice and video calls over the internet or VOIP calls. When activated, the ICSI device 10 blocks data packets that use ports 1720 and 5060 in either direction. It is important to note that all other data packets are passed without interference.

In FIG. 2, a table 30 indicates the two conditions of the ICSI device 10. In the disabled state (i.e., the ICSI device 10 is OFF) on the left, the green LED 18 is illuminated (or, in a bi-color LED, its green component is illuminated). The table 30 indicates that all ports 5060, 1720, ON or open, meaning that data traffic for those ports freely travels through the ICSI device 10 and between computer 3 and the network through the connectors, jacks or interfaces 26 and 28.

In the enabled state (i.e., the ICSI device 10 is ON resulting from a user actuating button 16a), the red LED 20 is illuminated (or the red component of a bi-color LED is lit) and the enabled state of the ports is shown on the right side of the table 30. Note that ports 5060 and 1720 are OFF or closed, meaning that data packets for those ports, both incoming and outgoing, are blocked by the ICSI device 10. Note, however, that the ports 161 and 25 remain ON or open, meaning that data packets for those ports travel unimpeded through the ICSI device 10 and between computer 3 and the network through the connectors, jacks or interfaces 26 and 28. If ICSI device 10 is OFF, it also does not impede data traffic used in voice calls. But if the ICSI device 10 is ON, it does block data traffic used in voice calls, both incoming and outgoing, so that no calls, such as VOIP telephone calls, can join, interrupt or interfere the video conference.

Referring back to FIG. 2, the ICSI device 10 further comprises a power jack 34 that is powered by a power supply 32, such as a conventional wall transformer, which plugs into the power jack 34.

Significantly, no access similar to that through serial, interface or port 31 is available through connectors 26 and 28. As a result, no user of the computer 3 or internet traffic can alter the operation of the circuitry 14 or change the programming. Consequently, no hackers can activate, de-activate, or modify the ICSI device 10, for example, or the circuitry 14, programming or data, via the internet. Similarly, the computer 3 in FIG. 2 cannot perform any of those functions as well, thereby enhancing the security and effectiveness of the ICSI device 10.

The ICSI device 10 of FIG. 2 is illustrated as an accessory for an existing computer 3. This accessory status is symbolically and schematically illustrated in FIG. 3, where the ICSI device 10 of FIG. 2 is shown separate and detachable from computer 3.

FIG. 4 is a flow chart representing a process or algorithm embodied in software or computer instructions stored in memory 14b (FIG. 2) in instructions that are executed by the processor 14a which illustrates processes undertaken by one form of the invention. Operation begins at decision block 40 where it is determined whether the ICSI device 10 is active. If not, the NO path is taken, and then block 44 is reached, wherein no data packets are passed if the device is not powered up.

If the ICSI device 10 is active, then the YES path is taken from decision block 42 and block 46 is reached. There, inquiry is made as to whether data ports are to be blocked. In one example, the ICSI examines the data packet header to determine what port it is headed to, and if intended for a port that is to be blocked, then it is blocked. For ease of illustration, ports are identified as type A ports or type B ports in block 46. In the example, type A ports are those that are not to be blocked, even when the ICSI device 10 is activated. For example, all packets reaching connector 28 in FIG. 2 are allowed to pass to connector 26 and vice versa. In contrast, packets identified using type B ports are to be blocked in the example when the ICSI device 10 is activated. For example, a data packet associated with port 5060, as in table 30 of FIG. 2, would exhibit the trait of a type B packet, namely, a data packet associated with a voice call and listing port 5060 or 1720 within itself. As another example, a data packet associated with port 161, as in table 30 of FIG. 2, would exhibit the trait of a type A packet, namely, a data packet associated with a video conference and listing port 161 within itself. In one form of the invention, type A packets are all those which are not type B packets. In one embodiment, the processor 14a examines the header of each data packet and, within the header, the IP address and port. The processor 14a blocks the type B packets in the example and permits other data packets, including type A packets, to pass. It should be understood that the ports may be on or off when a packet is passed or blocked.

The routine proceeds to blocks 48 and 50 where data packets are passed or blocked as appropriate.

### Additional Considerations

1. The ICSI device 10 in FIG. 2 can be activated prior to or even during a video conference. In addition, it can be activated after a video conference has begun. For example, if the device is activated during a video or voice call the active call will either be disconnected if the existing call relies on specific information being passed through the blocked ports or once the active call is finished the next call attempted will be blocked.

2. In one embodiment of the invention, no error detection is undertaken by the ICSI device 10. It is assumed that when data packets are passed and not blocked, they will travel unimpeded between connectors 28 and 26 in FIG. 2. That is, the examination process which determines the port affiliated with a data packet (or type states as in block 46 in FIG. 4) is a read-only process, which is a non-destructive process.

3. Thus, it should be understood that when the ICSI device 10 is activated, the ICSI device 10 prevents the call signal from either the calling or called device to be passed over the IP network connection. The ICSI device 10 blocks specific IP signaling traffic in both directions to prevent unattended, unwanted or rogue calls to connect. This is enabled or disabled by the single physical button 16a of switch 16 that the user must push or actuate to activate the ICSI device 10. A visible notification of the ICSI device 10 state is presented to the user identifying if call blocking or interrupting is either enabled or disabled.

4. The simplicity of the embodiment being described is that the ICSI device 10 is comprised of four physical pieces mentioned earlier and summarized as follows.

Piece 1. The ICSI device 10: which is the box or housing 10a that houses the circuitry 14, which includes processor(s) 14a and memory 14b, and the five previously described interfaces: (1) a line-in RJ45 Ethernet interface, jack or connector 26 in FIG. 2, (2) a computer RJ45 Ethernet interface or jack 28, (3) a serial Service interface or port 31, (4) a RJ45/RJ11 Button interface or jack 36, and (5) a VDC Power input interface or jack 34.

Pieces 2 and 3. The user interface/button or switch 16, which includes the large button 16a, to be placed within the same general area of the ICSI device 10 and is connected to it via a physical cable 27. The switch 16 is lighted and changes color based upon the ICSI device's 10 state of operation.

Piece 4. ICSI Power supply 32 provides VDC power to the ICSI device 10.

5. As mentioned earlier, ICSI device 10 is placed inline of the network interface cable 15 (FIG. 2) going to, for example, an IP codec device, video conference hardware or computer 17. As also previously mentioned, a significant feature of the embodiment being described is that the ICSI device 10 is not IP addressable and passes the IP address information presented by the network. The ICSI device 10 is not accessible or manageable through the network.

6. In one embodiment, the ICSI device 10 has the two functional states previously described:

State 1, DISABLED, which allows all IP traffic to flow to and from the ICSI device 10 is inline on the network interface; and

State 2, ENABLED, which allows all IP traffic to flow, with the exception of certain predetermined data packets, such as TCP or UDP packets using specific ports, such as 5060 for SIP or 1720 for H.323.

Any other session protocol used for a video or voice over IP application can be incorporated into the ICSI device 10 if call signaling is specified to a specific network port by that protocol. When the ICSI device 10 is in either the enabled or disabled state, all other network traffic is capable of passing through the device with the exception of the stated ports when in the Enabled state. This provides full management and monitoring capability to the ICSI device 10.

8. In another embodiment of the invention, the ICSI device 10 of FIG. 2 is affiliated with a single computer, which is operated by a single user, such as a desktop personal computer operated by an office worker. In this embodiment of the invention, the ICSI device 10 is not affiliated with, for example, a server at a node of the network or internet, which handles data traffic for multiple people.

9. In another embodiment of the invention and as mentioned earlier, the ICSI device 10 is independent of all programming and processes within the computer 3. For example, ICSI device 10 will pass and block data packets, as appropriate, irrespective of which programs are running on the computer 3, and as stated above, those programs on computer 3 do not and cannot affect the programming and operation of ICSI device 10.

10. In another embodiment of the invention, the sole means of activating and de-activating the ICSI device 10 in FIG. 2 is the switch 16 and button 16a. This presumes normal operation, of course. If a thunderstorm knocks out electric power, which represents non-normal operation, then, of course, the ICSI device 10 may become de-activated, but without a user's manipulation of switch 16. In general, if power is lost, data will not flow through ICSI device 10.

Differences exist between the invention and other approaches which also block data from reaching a computer. Three of such approaches, namely, firewalls, parental control software, and virus protection software, will be mentioned for ease of comparison and understanding of the features of the embodiments being described.

Virus protection software typically runs on computer 3, whereas the embodiment shown in FIG. 2 does not. In many, if not most, types of virus protection software, the identities of materials to be blocked is determined by a third party and not by the user or maker of computer 3, as in the case of the ICSI device 10. Virus protection software does not block voice calls, while the invention does. A significant feature of the invention is that an incoming voice call requires that computer 3 be equipped with the proper software to handle the call. Thus, incoming data packets either: (1) launch that software into operation or (2) are used by that software for a voice call, or (3) both (1) and (2). The invention blocks those data packets when the ICSI device 10 is enabled. A computer virus, which is blocked by anti-virus software, does not necessarily do that. The virus could merely be code which is inserted into program memory and then run by the processor. No software analogous to the voice call software is necessarily involved.

Parental control software may run on computer 3, while the preferred embodiments shown in FIG. 2 and described herein utilize the standalone ICSI device 10. Parental control software is designed not to be defeated by the person who is to be protected, namely, a child. For example, a parent selects a secret password, which activates the software, and the software runs until that password is entered, thereby unlocking the software. Thus, the child cannot de-activate the software because he lacks the password. In contrast, the embodiments described herein can be de-activated at will by activating switch 16. In some types of parental control software, the identities of the materials to be blocked are determined by a third party. In contrast, a user of the embodiments described herein determines what is blocked. Parental control software does not block voice calls, while the embodiments described herein does.

Computer firewalls do several things. They give partial or complete access to a computer system to a party who has proper identification. The invention does not do that. Firewalls can act like virus protection software, which is unlike the embodiments of the invention described, as explained above.

14. A significant feature of one form of the invention is that ICSI device 10 in FIG. 2 does not contain a message-based operating system. This lends to the simplicity of the ICSI device 10. In contrast, an operating system allows a more conventional or complex microprocessor to execute commands on collections of bytes, which are commonly called “files.” For example, in a DOS operating system, a command exists to copy a file (a collection of bytes) from one disc drive to another. Of course, this copying could be done by a simpler microprocessor, by transferring the bytes of the file individually, but that would plainly be quite tedious and time consuming.

In one form of the invention, ICSI device 10 contains a operating system that executes command sets. The operating system can be Linux or otherwise can be UNIX based.

Further, even if ICSI device 10 can be viewed as containing a rudimentary operating system, on the grounds that (1) data packets correspond to files, and (2) the device processes data packets, nevertheless, ICSI device 10 does not contain a message-based operating system

As stated above, in one form of the invention, the ICSI device 10 does not contain a message-based operating system which further lends to the simplicity of the solution for blocking voice calls during a video conference.

Nevertheless, under the invention, there are no commands of an operating system which are available to the user of the protected computer during normal operation of the invention. For example, the user cannot selectively order that packets be stored in a disc drive, or copied to another location. As another example, the user cannot append material to a packet. As a third example, a user cannot selectively erase packets.

Further, even if the invention is considered to contain an operating system, the invention does not contain the combination of (1) an operating system plus (2) application programs which run on that operating system.

Numerous substitutions and modifications can be undertaken without departing from the true spirit and scope of the invention. While the system, device, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An internet protocol interrupter device, comprising:
a) a first connector or interface adapted to be connected to a data packet-switched network;
b) a second connector or interface adapted to be connected to a computer;
c) circuitry which
i) examines data packets received from the network;
ii) blocks predetermined packets from reaching said second connector or interface which are found to originate from a predetermined port; and
iii) passes all other packets to said second connector or interface.

2. The internet protocol interrupter device according to claim 1, and further comprising:
d) a switch which selectively activates or de-activates the blocking of paragraph c)(ii).

3. The internet protocol interrupter device according to claim 2, in which de-activation causes all data packets received from the network to reach the second connector or interface.

4. The internet protocol interrupter device according to claim 1, wherein said device contains no devices by which microprocessor instructions can be loaded into the circuitry from the network.

5. The internet protocol interrupter device according to claim 1, in which input from the network can neither activate, nor de-activate, the blocking of paragraph c)(ii).

6. The internet protocol interrupter device according to claim 1, and further comprising a third connector or interface through which computer code can be loaded into memory of the circuitry.

7. The internet protocol interrupter device according to claim 6, wherein said third connector or interface is a serial port.

8. The internet protocol interrupter device according to claim 1, in which the circuitry comprises a processor adapted to:
i) examine data packets received from the computer via said second connector or interface;
ii) block packets from reaching said first connector or interface which are found to originate from a predetermined port; and
iii) pass all other data packets to the first connector or interface.

9. The internet protocol interrupter device according to claim 1, wherein said device has no Internet Protocol (IP) address.

10. The internet protocol interrupter device according to claim 2, in which no data packets are blocked during de-activation.

11. The internet protocol interrupter device according to claim 1, in which data packets which are blocked contain indicia that they are associated with a defined port address.

12. The internet protocol interrupter device according to claim 1, wherein said data packets are at least one of TCP packets or UDP packets using at least one of 5060 for SIP or 1720 for H.323.

13. An accessory for a computer, comprising:
a) circuitry for receiving data packets from a network;
b) a processor for
i) blocking packets of a predetermined type from reaching the computer, and
ii) passing other packets to the computer; and
c) a switch for selectively activating and de-activating the blocking.

14. The accessory according to claim 13, in which signals from the network can neither activate nor de-activate the blocking.

15. A device for a computer which holds video conferences over a network, comprising:
a) a filter which
i) receives data packets from the network;
ii) passes data packets affiliated with the video conference to the computer; and
iii) blocks data packets affiliated with a data port from reaching the computer; and
b) a switch which selectively activates and de-activates the blocking.

16. The device according to claim 15, in which the switch selectively activates and de-activates the blocking of paragraph (vi).

17. The device according to claim 15, wherein the filter has no IP address.

18. The device according to claim 15, wherein the filter is not programmable except by a predetermined computer.

19. The device according to claim 18, wherein the filter comprises a serial port adapted to permit said predetermined computer to be coupled to it so that the predetermined computer can program the filter.

20. An internet protocol call signal interruption method comprising the steps of:
a) receiving data packets from a network;
b) examining the packets; and
c) if examination shows that packets are affiliated with a specific port, then blocking such packets from reaching a computer.

21. The internet protocol call signal interruption method according to claim 20, and further comprising:
d) using the computer to hold or participates in a video conference during the examination.

22. The internet protocol call signal interruption method according to claim 20, and further comprising:
d) passing data packets to the computer which are found not to be affiliated with a specific port.

23. The internet protocol call signal interruption method according to claim 20, in which packets which are blocked contain an indication of originating from one of a group of predetermined ports.

24. The internet protocol call signal interruption method according to claim 23 wherein said group of predetermined ports are 5060 or 1720.

25. A method, comprising:
a) examining packets received from a network which are directed to a computer;
b) if packets are found to originate from a predetermined port, then blocking such packets from reaching the computer; and
c) allowing all other packets to reach the computer.

26. An interruption device for use during a video conference, said interruption device comprising:
a housing adapted to couple a network coupled to a video conference computer or hardware and at least one computer used by a participant in said video conference;
a processor;
memory for storing information regarding at least one predetermined IP data packet that is to be blocked by said interruption device; and
said processor being adapted or configured to execute a sequence of computer instructions also stored in memory for evaluating data packets communicated between said network and said at least one computer and to block any of said data packets that comprise said at least one predetermined IP data packet, wherein said at least one predetermined IP data packet is associated with a call.

27. The interruption device as recited in claim 26 wherein said call is a voice over internet protocol (VOIP) call.

28. The interruption device as recited in claim 26 wherein said interruption device has no associated IP address.

29. The interruption device as recited in claim 28 wherein said interruption device is not programmable by said at least one computer or any computer coupled to said network.

30. The interruption device as recited in claim 26 wherein said network is an IP network.

31. The interruption device as recited in claim 30 wherein said IP network comprises the internet.

32. The interruption device as recited in claim 26 wherein said interruption device comprises a plurality of interfaces or jacks;
at least a first one of said plurality of interfaces or jacks being adapted to be coupled to said at least one computer;
at least a second one of said plurality of interfaces or jacks being adapted to be coupled to said network;
said plurality of interfaces or jacks being adapted to permit said interruption device to be placed in series between said network and said at least one computer.

33. The interruption device as recited in claim 32 and further comprising:
a switch for activating and deactivating said interruption device;
wherein when said switch activates said interruption device, said processor evaluates said data packets communicated between said network and said at least one computer and subsequently blocks any of said data packets that comprise said at least one predetermined IP data packet and when said switch deactivates said interruption device, said processor does permits all data packets to be passed between said at least a first one of said plurality of interfaces and said at least a second one of said plurality of interfaces, including said at least one predetermined IP data packet.

34. The interruption device as recited in claim 33 wherein said switch is a manual switch having a button that can be activated by a participant in the video conference to cause said interruption device to become either activated or deactivated.

35. The interruption device as recited in claim 33 wherein said interruption device further comprises notifying indicia to indicate to users when the interruption device is either activated or deactivated.

36. The interruption device as recited in claim 33 wherein said call is a voice over internet protocol (VOIP) call.

37. The interruption device as recited in claim 33 wherein said at least one predetermined IP data packet comprises a TCP packet or a UDP packet using at least one of 5060 port or 1720 port.

38. The interruption device as recited in claim 33 wherein said at least one predetermined IP data packet comprises both a TCP packet or a UDP packet using at least one of 5060 port or 1720 port.

39. The interruption device as recited in claim 33 wherein said processor and said computer instructions cannot be controlled or changed from either said network or said at least one computer.

40. The interruption device as recited in claim 26 wherein it further comprises a dedicated interface or jack adapted to permit a programming computer to be coupled thereto so that said programming computer can program at least one of said processor, said computer instructions and said information;
wherein said programming computer is not participating in said video conference.

41. The interruption device as recited in claim 26 wherein said computer instructions are adapted to block data associated with both video and voice calls.

42. The interruption device as recited in claim 26 wherein it is a standalone device and comprises a manual switch or button that can be manually actuated by a user for activating and deactivating said interruption device such that when said manual switch is actuated in a first state during which said interruption device is active, said data packets communicated between said network and said at least one computer are evaluated by said processor and any of said data packets that comprise said at least one predetermined IP data packet are blocked while permitting other data packets to pass that do not comprise said at least one predetermined IP data packet to pass and when said switch is in a second state during which said interruption device is deactivated, said processor permits all data packets, including said at least one predetermined IP data packet to be passed between said network and said at least one computer.

43. The interruption device as recited in claim 42 wherein during said first state, said interruption device blocks said at least one predetermined IP data packet both to and from each of said network and said computer.

44. The interruption device as recited in claim 42 wherein said manual switch is on during said first state and said manual switch is off during said second state.

45. The interruption device as recited in claim 42 wherein said at least one predetermined packet is associated with a predetermined port associated with a voice call.

46. The interruption device as recited in claim 45 wherein said voice call is a voice over internet protocol (VOIP) call.

47. An apparatus, comprising:
a) a first connector, connectable to a packet-switched network;
b) a second connector, connectable to a protected computer;
c) circuitry which
i) examines data packets received from the network;
ii) blocks packets from reaching the second connector which are found to originate from a predetermined port; and
iii) passes all other packets to the second connector;
wherein
A) the protected computer cannot determine which packets are blocked in paragraph c),
B) the protected computer cannot determine which packets are passed in paragraph c),
C) no commands received through the first connector can determine which packets are blocked in paragraph c). and
D) no commands received through the first connector can determine which packets are passed in paragraph c).

48. The apparatus according to claim 47 which provides to a user of the protected computer no ability to selectively copy a packet.

49. The apparatus according to claim 47 and further comprising a switch which activates and de-activates the blocking of paragraph c).

50. The apparatus according to claim 49, in which no other agency apart from the switch is capable of activating and de-activating the blocking of paragraph c).
